(19) United States
(12) Patent Application Publication
(10) Pub. No.: US 2025/0371914 A1
(43) Pub. Date: Dec. 4, 2025

(54) FLEETWIDE SERVERLESS FUNCTIONAL SAFETY PROTECTION FOR HYBRID CLOUD INTEROPERABILITY

(71) Applicant: Red Hat, Inc., Raleigh, NC (US)

(72) Inventors: Leigh Griffin, Waterford (IE); Anthony Carroll, Waterford (IE)

(21) Appl. No.: 18/732,142

(22) Filed: Jun. 3, 2024

(51) Int. Cl. G07C 5/00

(52) U.S. Cl. CPC G07C 5/008

(57) ABSTRACT

Aspects of the present disclosure relate to fleetwide serverless functional safety protection for hybrid cloud interoperability. More specifically, a processing device receives, from a requesting entity, a message comprising an indication of a resource of a vehicle and an indication of the requesting entity. The processing device determines, based on the message and a set of safety rules for a set of resources of the vehicle, a safety level of the resource. The processing device exposes, to the requesting entity, a serverless function corresponding to the resource of the vehicle from amongst a plurality of serverless functions based on the safety level.

### TECHNICAL FIELD

Aspects of the present disclosure relate to connected vehicles, and more particularly, to fleetwide serverless functional safety protection for hybrid cloud interoperability.

### BACKGROUND

A connected vehicle refers to a vehicle that is capable of communicating with entities outside of the vehicle and/or inside of the vehicle via a wired connection or a wireless connection. In an example, the entities may be or include a user device (e.g., a smartphone) of a user inside or outside of the vehicle, other vehicles, cloud platform, or a roadside unit (RSU). A connected vehicle may provide services to passengers (e.g., music services) based on communicating with the entities. A connected vehicle may also support or enhance self-driving functionality as well. A connected vehicle may be capable of vehicle-to-everything (V2X) communications. V2X communications include vehicle-to-infrastructure (V2I) communications, vehicle-to-vehicle (V2V) communications, vehicle-to-cloud (V2C) communications, vehicle-to-pedestrian (V2P) communications, vehicle-to-device (V2D) communications, vehicle-to-network (V2N) communications, and vehicle-to-grid (V2G) communications.

### BRIEF DESCRIPTION OF THE DRAWINGS

The described aspects and the advantages thereof may best be understood by reference to the following description taken in conjunction with the accompanying drawings. These drawings in no way limit any changes in form and detail that may be made to the described aspects by one skilled in the art without departing from the spirit and scope of the described aspects.

FIG. 1 is a block diagram that illustrates an example of a system in accordance with some aspects of the present disclosure.

FIG. 2A is a block diagram that illustrates an example of a system in accordance with some aspects of the present disclosure.

FIG. 2B is a block diagram that illustrates an example of a system in accordance with some aspects of the present disclosure.

FIG. 3 is a flow diagram of a method for fleetwide serverless functional safety protection for hybrid cloud interoperability in accordance with some aspects of the present disclosure.

FIG. 4 is a flow diagram of a method for fleetwide serverless functional safety protection for hybrid cloud interoperability in accordance with some aspects of the present disclosure.

FIG. 5 is a block diagram of an example of a computer system that may perform one or more of the operations described herein in accordance with some aspects of the present disclosure.

### DETAILED DESCRIPTION

A connected vehicle refers to a vehicle that is capable of communicating with entities outside of the vehicle and/or inside of the vehicle via a wired connection or a wireless connection. In an example, the entities may be or include a user device (e.g., a smartphone) of a user inside or outside of the vehicle, other vehicles, a cloud platform, or an RSU. A connected vehicle may provide services to passengers (e.g., music services) based on communicating with the entities. A connected vehicle may also support or enhance self-driving functionality as well. For instance, the connected vehicle may be capable of autonomous operation or semi-autonomous operation. A connected vehicle may be capable of V2X communications. V2X communications include V2I communications, V2V communications, V2C communications, V2P communications, V2D communications, V2N communications, and V2G communications.

As noted above, a connected vehicle is capable of exchanging communications with an entity. The communications may enable the entity to access resources (e.g., vehicle control systems, vehicle cabin control systems, applications, computing resources, application programming interfaces (APIs)) of the connected vehicle in order for the connected vehicle and/or the entity to perform one or more actions (e.g., stream a movie from a smartphone to a display screen in the connected vehicle, unlock a door of the connected vehicle, etc.). If the entity is a trusted entity (e.g., a trusted application), a security risk of allowing the trusted entity to access the resource may be relatively low. However, if the entity is a non-trusted entity (e.g., a non-trusted application), the security risk of allowing the entity to access the resource may be relatively high. As such, the connected vehicle may block communications with the non-trusted entity, even if the non-trusted entity is not actually a malicious entity.

The present disclosure addresses the above-noted and other deficiencies by using a processing device (e.g., a processing device of a connected vehicle) that receives, from a requesting entity, a message comprising an indication of a resource of a vehicle and an indication of the requesting entity. The processing device determines, based on the message and a set of safety rules for a set of resources of the vehicle, a safety level of the resource. The processing device exposes, to the requesting entity, a serverless function corresponding to the resource of the vehicle from amongst a plurality of serverless functions based on the safety level. Vis-à-vis exposing the serverless function corresponding to the resource based on the safety level, the processing device may mitigate security risks associated with a connected vehicle when the connected vehicle communicates with different entities. For instance, the serverless function abstracts a capability of the resource (i.e., what actions the resource is capable of performing) from an implementation of the resource (i.e., how the resource performs the action). As such, the requesting entity and the connected vehicle may communicate in a manner that enables services to be delivered to/from the connected vehicle without exposing potential vulnerabilities (i.e., via an implementation of the resource) of the connected vehicle. For instance, the connected vehicle may expose a limited view of a resource to a non-trusted entity that enables the connected vehicle and/or the non-trusted entity to perform an action in a manner that does not pose a security risk to the connected vehicle.

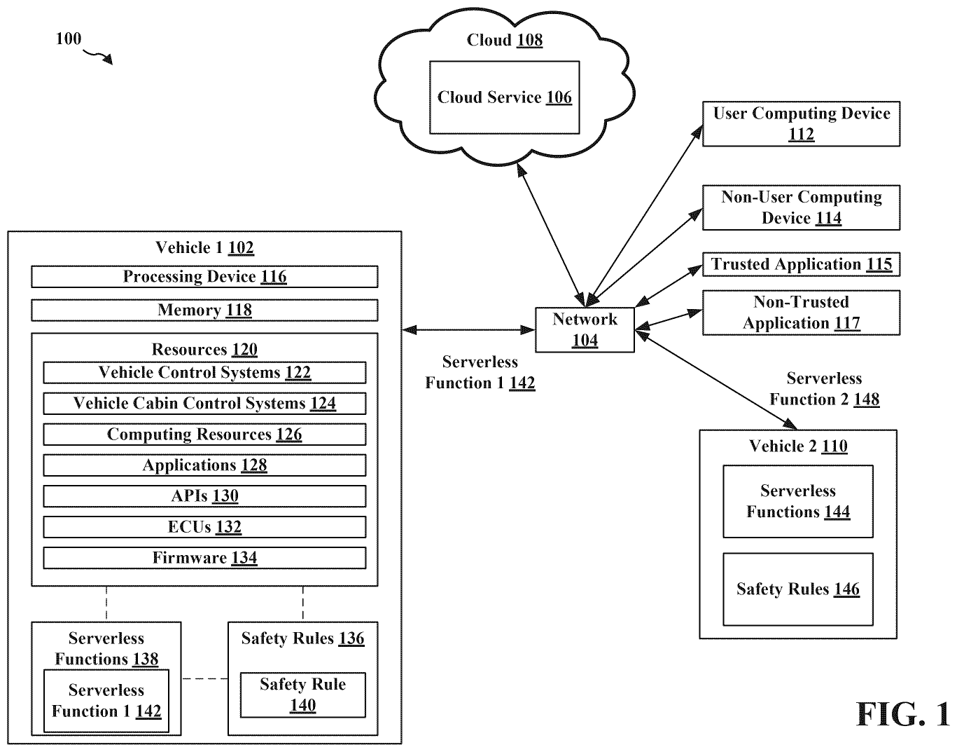

FIG. 1 is a block diagram 100 that illustrates an example of a system in accordance with some aspects of the present disclosure. The system includes a first vehicle 102. The first vehicle 102 is a connected vehicle. The system further includes one or more requesting entities that are in wired communication or wireless communication with the first vehicle 102 (or with one another) by way of a network 104. The one or more requesting entity may be or include a cloud service 106 in a cloud 108 (i.e., a cloud computing platform), a second vehicle 110, a user computing device 112, a non-user computing device 114, a trusted application 115, or a non-trusted application 117. The one or more entities may also include a fleet management system (not depicted in FIG. 1) that manages a fleet of connected vehicles including the first vehicle 102. In some aspects, the fleet management system is implemented as the cloud service 106.

The first vehicle 102 may refer to a device that is capable of transporting people or goods or that otherwise moves about an environment. In an example, the first vehicle 102 may be a car, a truck, a motorcycle, a bus, a train, a drone, an airplane, or a helicopter. The first vehicle 102 is a connected vehicle, that is, the first vehicle 102 is capable of communicating with entities (e.g., requesting entities) outside of the vehicle and/or inside of the vehicle. The first vehicle 102 may be an autonomous vehicle (i.e., a vehicle that is capable of operating without human input), a semi-autonomous vehicle (i.e., a vehicle that is capable of performing some operating tasks without human input), or a non-autonomous vehicle (a vehicle that operates based on human input).

The first vehicle 102 includes a processing device 116 (e.g., processors, central processing units (CPUs)) and memory 118 (e.g., random access memory (RAM)). The first vehicle 102 vehicle may also include storages devices (not depicted in FIG. 1), such as a hard-disk drive (HDD)) and a solid-state drive (SSD), etc. A storage device may include a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The first vehicle 102 may also include other hardware devices (e.g., a sound card, a video card, etc.) not depicted in FIG. 1.

The network 104 may be a public network (e.g., the Internet), a private network (e.g., a local area network (LAN) or wide area network (WAN)), or a combination thereof. In one example, the network 104 may include a wired infrastructure or a wireless infrastructure, which may be provided by one or more wireless communications systems, such as a WiFi™ hotspot connected with the network 104 and/or a wireless carrier system that can be implemented using various data processing equipment, communication towers (e.g., cell towers), etc. In another example, the network 104 may include a wireless infrastructure which may be provided by a Bluetooth® transmitter/receiver. In a further example, the network 104 may include a wired network which may be provided by universal serial bus (USB) hardware. The network 104 may carry communications (e.g., data, message, packets, frames, etc.) between the first vehicle 102 and the one or more requesting entities.

The first vehicle 102 includes resources 120 used by the first vehicle 102 to perform actions. The resources 120 may include vehicle control systems 122 that operate to control the first vehicle 102 in an environment. For example, the vehicle control systems 122 may include a propulsion system, a steering system, a braking system, and a navigation system. The vehicle control systems 122 may also include systems that convey intent of the first vehicle 102 (or a driver of the first vehicle 102) to other vehicles and/or people in an environment, such as an external lighting system (e.g., headlights, brake lights, etc.), a turn signaling system, and an external audio system (e.g., a car horn). The vehicle control systems 122 may also include systems that aid a driver of the vehicle in driving the vehicle, such as a windshield wiper system or a defroster system.

The resources 120 may include vehicle cabin control systems 124 that operate to provide certain functionality within the first vehicle 102. For example, the vehicle cabin control systems 124 may include a climate control system (i.e., a heating system and/or a cooling system), a locking/unlocking system (e.g., a door locking/unlocking system, a trunk locking/unlocking system), a seat adjustment control system (i.e., a seat recliner system), a window system, an internal audio system (e.g., a speaker system), a dashboard control system, a center console control system, and/or a video display system (e.g., a display screen that presents visual content to passengers) of the first vehicle 102.

The resources 120 further include computing resources 126. The computing resources 126 may include the processing device 116, the memory 118, and/or storage device(s) (not depicted in FIG. 1) of the first vehicle 102. In some aspects, the computing resources 126 include hardware, software, and/or firmware of a computing device within the first vehicle 102. In some aspects, the computing device may be or may be included in the first vehicle 102. In some aspects, the computing resources 126 are associated with the vehicle control systems 122 and/or the vehicle cabin control systems 124.

The resources 120 may include applications 128 executed by processing devices (e.g., the processing device 116) of the first vehicle 102. The applications 128 may be or include machine executable instructions. In an example, the applications 128 may include a navigation application that provides the driver of the first vehicle 102 with instructions on navigating from an origin location to a destination location. In another example, the applications 128 may include a gaming application that provides a gaming experience to passengers of the vehicle. In some aspects, the computing resources 126 may execute the applications 128. In some aspects, the applications 128 are associated with the vehicle control systems 122 and/or the vehicle cabin control systems 124. In some aspects, the applications 128 include one or more operating system(s) (OS(s)) of the first vehicle 102. The OS(s) of the first vehicle 102 may manage the execution of other components (e.g., software, applications, etc.) of the first vehicle 102 and/or may manage access to the hardware (e.g., processors, memory, storage devices, etc.) of the first vehicle 102.

The resources 120 may include application programming interfaces (APIs) 130 of the first vehicle 102. The APIs 130 may define how the first vehicle 102 (or a resource or a system thereof) communicates with a requesting entity. In an example, the APIs 130 may include an API that enables a mobile application executing on a smartphone to unlock doors of the first vehicle 102.

The resources 120 may include electronic control units (ECUs) 132 of the first vehicle 102. An ECU may refer to an embedded system that controls one or more electrical systems or subsystems of the first vehicle 102. An ECU may include a core (i.e., a microcontroller), memory, inputs, outputs, communication links, and embedded software. The embedded software may include an OS. In some aspects, each of the ECUs 132 includes an instance of the same OS. In other aspects, each of the ECUs 132 (or some of the ECUs 132) include(s) a different OS (i.e., an OS configured for a particular purpose of a particular ECU). Some or all of the ECUs 132 may control the vehicle control systems 122 and/or the vehicle cabin control systems 124. In an example, the ECUs 132 include an engine control module (ECM), a powertrain control module (PCM), a transmission control module (TCM), a break control module (BCM), a central control module (CCM), a central timing module (CTM), a general electronic module (GEM), a body control module (BCM), and a suspension control module (SCM).

The resources 120 may further include firmware 134 of the first vehicle 102. The firmware 134 may refer to software that provides low-level control of computing device hardware of the first vehicle 102.

The cloud 108 may include a group of computing devices (not depicted in FIG. 1). A computing device in the cloud 108 may include elements such as a processor, a memory, a storage device, a network interface device, etc. In an example, the cloud 108 is a public cloud. In another example, the cloud 108 is a private cloud. In an example, the cloud 108 may be implemented as one or more data centers.

The cloud 108 may provide cloud computing associated functionality to the first vehicle 102 (as well as other entities). Cloud computing refers to a paradigm by which computing services/resources, such as servers, storage, databases, networking, software, analytics, and intelligence, are delivered over the Internet to devices. Cloud computing may be characterized by on-demand self-service (i.e., the cloud 108 can automatically provision resources without human interaction with a service provider), broad network access (i.e., the cloud 108 can be accessed by different devices with varying capabilities, such as vehicles, mobile phones, tablets, smartphones, laptops, and workstations), resource pooling (i.e., the cloud 108 can serve multiple different clients), rapid elasticity (i.e., the cloud 108 can dynamically scale computing resources both upwards and downwards based on needs of clients), and measured service (i.e., the cloud 108 monitors computing resources used by clients). The cloud 108 may be distributed over multiple data centers across disperse geographical locations. In some aspects, the cloud 108 may be part of a hybrid cloud. A hybrid cloud may refer to a mixed computing environment where applications are executed using a combination of computing, storage, and services in different environments. The different environments may include public clouds (i.e., clouds available to the general public), private clouds (i.e., clouds not available to the general public), on-premises data centers, servers, vehicles, user computing devices, and non-user computing devices.

The cloud 108 may provide the cloud service 106 to entities (e.g., the first vehicle 102, the user computing device 112, etc.), that is, processing devices of the cloud 108 may execute machine executable instructions that cause the processing devices to provide the cloud service 106 to the entities. In an example, the cloud service 106 is a fleet management system that manages a fleet of connected vehicles including the first vehicle 102 and the second vehicle 110. With more particularity, the fleet management system may be configured to push software and/or firmware updates to the fleet of connected vehicles, track locations and other operational parameters of the fleet of connected vehicles, receive diagnostic information from the fleet of connected vehicles, and/or facilitate predictive maintenance for the fleet of connected vehicles. In some aspects, the fleet management system may also coordinate collaborative navigation between the fleet of connected vehicles (e.g., vehicle platooning).

The user computing device 112 may be a computing device operated by a user. The user computing device 112 is separate from the first vehicle 102, that is, the first vehicle 102 does not include the user computing device 112. In an example, the user computing device 112 may be or include a desktop computing device, a laptop computing device, a tablet computing device, a gaming console, a wearable computing device (e.g., a smartwatch, an extended reality (XR) headset, etc.), or a smartphone. The user computing device 112 may be located inside or outside of the first vehicle 102. In an example, a driver of the first vehicle 102 or a passenger of the first vehicle 102 carries the user computing device 112.

The non-user computing device 114 may be a computing device unassociated with a user. In an example, the non-user computing device 114 may be or include a roadside unit (RSU) or a device that is otherwise part of a traffic infrastructure. An RSU may refer to a device installed alongside roads or highways to facilitate communication between vehicles and transport infrastructure. In another example, the non-user computing device 114 may be an Internet-of-Things (IoT) device. An IoT device may refer to a device that includes sensors, processing capability, software, and other technologies that connects and exchanges data over a network (e.g., the network 104). In another example, the non-user computing device 114 may be a server computing device.

The trusted application 115 may be an application that has undergone a safety certification. For example, the trusted application 115 may be a functional safety (FuSA) compliant application (described below). The non-trusted application 117 may be an application that has not undergone a safety certification. For example, the non-trusted application 117 may be a non-FuSa compliant application.

The second vehicle 110 may include some or all of the elements described above with respect to the first vehicle 102. For example, the second vehicle 110 may include a processing device, memory, resources, etc. (not depicted in FIG. 1). In some aspects, the first vehicle 102 is manufactured by a first manufacturer and the second vehicle 110 is manufactured by a second manufacturer, where the first manufacture and the second manufacturer are different.

The first vehicle 102 may include/be associated with internal FuSA mechanisms and protections. FuSa may be defined as the absence of unacceptable risk due to hazards caused by malfunctioning behavior of electrical and/or electronic systems of a vehicle. A goal of FuSa may be to prevent systematic design failures and to detect and control random hardware faults. A FuSa verified application or service may refer to an application or a service that the FuSa mechanisms and protections may be constrained by an internal architecture of the first vehicle 102; however, in some aspects, the FuSA mechanisms and protections may be enhanced with cloud-based solutions for fleet management. Enhancing the FuSa mechanisms and protections in the aforementioned manner may present a potential interference mechanism through the exposure of capabilities of the first vehicle 102 to non-verified FuSa applications and services. The potential interference mechanisms may be challenging to control due to the existence of a variety of applications and car manufacturers.

FuSa may be related to an automotive safety integrity level (ASIL). ASIL may refer to a risk classification scheme that helps to define safety requirements. A malfunctioning resource (e.g., a resource in the resources 120) of a vehicle may be identified by one of four ASIL levels: ASIL A (lowest hazard), ASIL B, ASIL C, or ASIL D (highest hazard). An ASIL level of a resource may be based on a severity of the failure of the resource, a likelihood of the failure occurring, and how much time the vehicle is exposed to the failure of the resource.

Some aspects presented herein pertain to a mechanism that abstracts capabilities/functions of a plurality of vehicles (e.g., the first vehicle 102 and the second vehicle 110) to a cloud service (e.g., the cloud service 106) in a manner that is compliant with FuSa in order to facilitate increased safety, efficiency, and scalability. In some aspects, each vehicle operates as a serverless entity in order to facilitate increased security. A serverless entity may refer to an entity that exposes functionality of the entity without exposing an underlying implementation of the functionality. For example, a vehicle in the fleet may expose that a braking system of the vehicle controls the brakes of the vehicle without exposing how the braking system actually operates to control the brakes of the vehicle. Each vehicle may expose its respective capabilities and functions to a cloud service through a secure API that maintains security and safety standards for vehicle operation. In some aspects, the cloud service may set the security and safety standards on a per vehicle basis through configuration mechanisms that govern ASIL levels and other FuSa considerations. As such, a vehicle in the fleet may control whether a resource of the vehicle is exposed and how the resource is exposed. Such control may enable a vehicle in the fleet to interact with other entities in a safe and predictable manner without exposing inner APIs of the vehicle, as exposing inner APIs of the vehicle can be a security risk.

In one aspect, the cloud service acts as a central FuSa manager that monitors and manages software functions of each vehicle in the fleet in real-time. For instance, the cloud service can perform health status checks, fault detection, and correction actions that software of a vehicle has taken. The cloud service may remotely execute diagnostics, initiate software updates, and provide predictive maintenance services across the fleet in order to facilitate continuous and safe operations. Furthermore, the cloud service may manage the fleet in a manner that conforms to FuSa.

In one aspect, the cloud service, an IoT device, and/or the vehicle may activate a resource when an action of the cloud service and/or the vehicle is to utilize the resource and the cloud service, the IoT device, and/or the vehicle may deactivate the resource after the action has been performed. As such, the resource may be consumed when a function is running (i.e., when an action is performed) and the resource may not be consumed when the function is not running (i.e., when the action has already been performed), which may result in reduced utilization of the resource.

The first vehicle 102 obtains safety rules 136 for the resources 120. For example, the cloud service 106 may be a fleet management system that provisions the first vehicle 102 with the safety rules 136 (e.g., as part of a manufacturing process, as part of a deployment process subsequent to manufacturing, etc.). In one aspect, the safety rules 136 indicate a respective safety level for each of the resources 120. In another aspect, the safety rules 136 may include information that enables the first vehicle 102 to determine a respective safety level for each of the resources. In one aspect, the safety rules 136 may be implemented as a rules engine. In one aspect, the safety rules 136 may be referred to as a FuSa configuration. In an example, the safety rules 136 may be included in a file, such as a JavaScript Object Notation (JSON) file, an extensible markup language (XML) file, or a Yet Another Markup Language (YAML) file. It is contemplated that the safety rules 136 may be updated over time based on new resources being added to the resources (e.g., new applications being installed on the first vehicle 102). For example, the cloud service 106 may periodically transmit updates to the safety rules 136 to the first vehicle 102. Although not depicted in FIG. 1, the first vehicle 102 may store the safety rules 136 in computer-readable storage of the first vehicle 102.

The first vehicle 102 also obtains serverless functions 138 for the resources 120. For example, the cloud service 106 may be a fleet management system that provisions the first vehicle 102 with the serverless functions 138 (e.g., as part of a manufacturing process, as part of a deployment process subsequent to manufacturing, etc.). The serverless functions 138 abstract capabilities of the resources 120 from implementations of the resources. For instance, a serverless function for a climate control system of the first vehicle 102 may indicate that the climate control system of the first vehicle 102 is capable of raising or lowering a temperature of the first vehicle 102, but does not indicate how the climate control system of the first vehicle 102 raises or lowers the temperature of the first vehicle 102. In another example, a serverless function for an application executing on the vehicle indicates functionality of the application, but does not indicate how the application performs the functionality. The serverless functions 138 may define allowed parameters (e.g., data types) in communications between the first vehicle 102 and requesting entities. Although not depicted in FIG. 1, the first vehicle 102 may store the serverless functions 138 in computer-readable storage of the first vehicle 102.

The first vehicle 102 receives (e.g., in a message), from a requesting entity, an indication of a resource in the resources 120 and an indication of the requesting entity. In an example, the requesting entity may be or include the cloud 108, the cloud service 106, the user computing device 112, the non-user computing device 114, the trusted application 115, the non-trusted application 117, or the second vehicle 110. The first vehicle 102 may receive the indication of the resource and the indication of the requesting entity via the network 104.

The first vehicle 102 determines, based on the indication of the resource, the indication of the requesting entity, and the safety rules 136, a safety level of the resource. For instance, in one aspect, the first vehicle 102 may identify a safety rule 140 in the safety rules 136 based on the indication of the requesting entity and the indication of the resource. The safety rule 140 may include the safety level. In another aspect, the safety rule 140 may indicate the safety level and the first vehicle 102 may determine the safety level based on the safety rule 140. In an example, the safety rule 140 may be an ASIL classification. For example, if the resource is associated with brakes of the first vehicle 102, the safety rule 140 may be ASIL D, whereas if the resource is associated with non-braking taillights of the first vehicle 102, the safety rule 140 may be ASIL A.

The first vehicle 102 may identify a first serverless function 142 in the serverless functions 138 that corresponds to the resource based on the safety level (or the safety rule 140). The first serverless function 142 abstracts a capability of the resource from an implementation of the resource. As such, the first serverless function 142 may facilitate increased security at the first vehicle 102 by limiting the exposure of information that could potentially be used to compromise the vehicle (e.g., via a cyberattack, via a software error inadvertently introduced by data shared by the first vehicle 102 with the requesting entity, etc.) while still enabling the requesting entity and the first vehicle 102 to communicate. The first serverless function 142 may define a level of access to the resource. For example, if the safety level indicates that the resource has a relatively high hazard potential (e.g., to the first vehicle 102, occupants of the first vehicle 102, other vehicles, etc.), the first serverless function 142 may define a relatively restricted level of access to the resource, whereas if the safety level indicates that the resource has a relatively low hazard potential, the first serverless function 142 may define a relatively permissive level of access to the resource. Additionally, or alternatively, the first serverless function 142 may be based on the requesting entity. For example, if the requesting entity is a trusted entity (e.g., a fleet management system), the first serverless function 142 may define a relatively permissive level of access to the resource, whereas if the requesting entity is a non-trusted entity (e.g., an unknown device), the first serverless function 142 may define a relatively restricted level of access to the resource. As such, it is understood that a given resource of the first vehicle 102 may have one or more than one serverless function assigned thereto.

The first vehicle 102 exposes, to the requesting entity, the first serverless function 142 corresponding to the resource of the first vehicle 102 from amongst the serverless functions 138 based on the safety level. For instance, the first vehicle 102 may transmit, to the requesting entity, an indication of the first serverless function 142 corresponding to the resource of the vehicle from amongst the serverless functions 138 based on the safety level. In an example, the indication of the first serverless function 142 may indicate a capability of the resource without indicating implementation details of the resource. In a specific example, the indication of the first serverless function 142 may indicate allowed parameters (e.g., data types used in API calls) in communications between the first vehicle 102 and the requesting entity.

The first vehicle 102 may receive, from the requesting entity, a request that indicates an action with respect to the resource based on the (exposed) first serverless function 142. In an example, the action may be receiving data from the requesting entity, transmitting data to the requesting entity, transmitting data to another entity, receiving data from another entity, controlling the first vehicle 102, controlling a cabin system of the first vehicle 102, or updating a vehicle system of the first vehicle 102. In a specific example, the action may be enabling a mobile device of a passenger of the first vehicle 102 to stream a video to a display device of the first vehicle 102. In another specific example, the action may be locking or unlocking a door of the first vehicle 102.

As indicated above, the request may be based on the first serverless function 142. In an example, the request includes parameters defined by the first serverless function 142. For example, the request may be a particular type of API call based on the first serverless function 142. For instance, if the determined safety level corresponds to a relatively high hazard level, the API call may be a type corresponding to a relatively limited level of access to an application executing on the vehicle, whereas if the determined safety level corresponds to a relatively low hazard level, the API call may be a type corresponding to a relatively greater level of access to an application executing on the vehicle. In one aspect, if the request includes parameters not permitted by the first serverless function 142, the first vehicle 102 may reject the request.

The first vehicle 102 may perform the action based on the request. For example, the first vehicle 102 may receive data from the requesting entity, transmit data to the requesting entity, transmit data to another entity, receive data from another entity, control the first vehicle 102, control a cabin system of the first vehicle 102, or update a vehicle system (i.e., update software and/or firmware of the vehicle system) of the first vehicle 102.

Although the description above has described the message (that indicates the resource and the indication of the requesting entity) and the request that indicates the action with respect to the resource as separate, other possibilities are contemplated. In some aspects, the message further indicates the request/action with respect to the resource. In such aspects, exposing the first serverless function may include determining whether the message/request/action entails accessing resources of the first vehicle 102 that conform to a safety level of the resource. Upon positive determination, the first vehicle 102 may process the request/action. Upon negative determination, the first vehicle 102 may reject the request/action.

In some aspects, the first vehicle 102 may selectively activate a resource based on the request and selectively deactivate the resource after performing the action indicated by the request in order to limit usage of the resource. For instance, if the request indicates that the first vehicle 102 is to broadcast an identifier for a passenger (e.g., an electronic business card) of the first vehicle 102, the first vehicle 102 may activate a network interface device for a period of time in order to broadcast the identifier for the passenger. The first vehicle may then deactivate the network interface device after the identifier for the passenger has been broadcast.

In some aspects, the second vehicle 110 may include serverless functions 144 and safety rules 146. The serverless functions 144 and the safety rules 146 may be similar or identical to the serverless functions 138 and safety rules 136, respectively. Using a process similar to that described above, the second vehicle 110 may identify and expose a second serverless function 148 in the serverless functions 144 to the first vehicle 102. The first vehicle 102 and the second vehicle 110 may exchange communications in a secure manner based on the (exposed) first serverless function 142 and the (exposed) second serverless function 148.

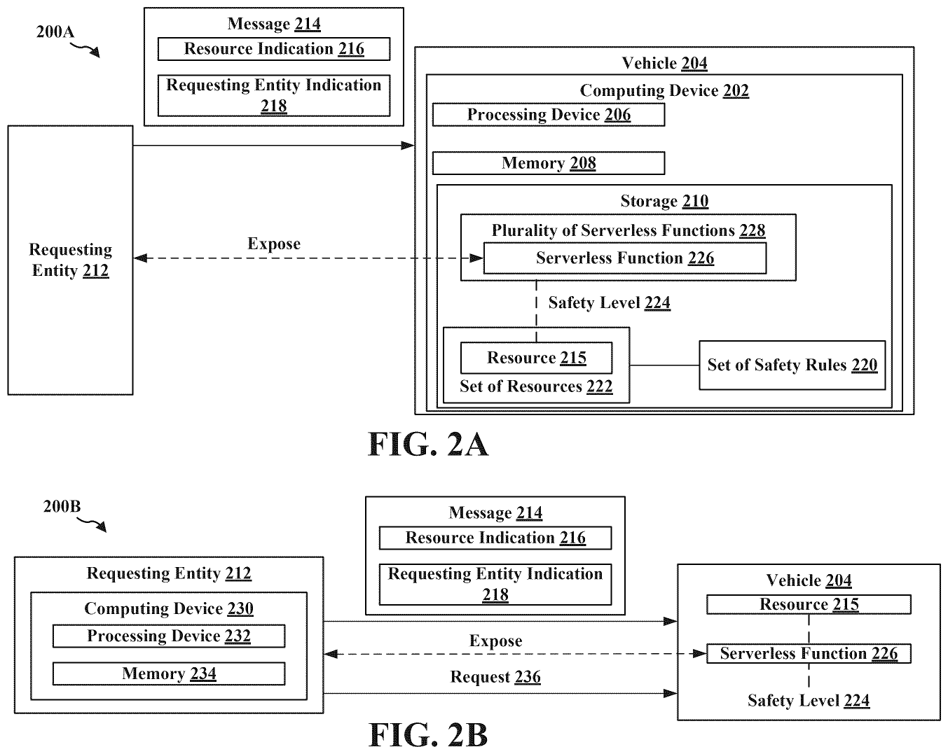

FIG. 2A is a block diagram 200A that illustrates an example of a system in accordance with some aspects of the present disclosure. The system includes a computing device 202. The computing device 202 may be included in a vehicle 204. In one aspect, the computing device 202 is manufactured by a manufacturer of the vehicle. In another aspect, the computing device 202 is manufactured by a non-manufacturer of the vehicle and subsequently added to the vehicle during a manufacturing process. In some aspects, the computing device 202 is the vehicle 204 and the vehicle 204 is the computing device 202. The computing device 202 includes a processing device 206 and memory 208. The computing device 202 also includes storage 210. In some aspects, the storage 210 is the memory 208.

The computing device 202 receives, from a requesting entity 212, a message 214 including a resource indication 216 (i.e., an indication of a resource 215 of the vehicle 204) and a requesting entity indication 218 (i.e., an indication of the requesting entity 212). The computing device 202 determines, based on the message 214 and a set of safety rules 220 for a set of resources 222 of the vehicle 204, a safety level 224 of the resource 215. The computing device 202 exposes (e.g., by the processing device 206), to the requesting entity 212, a serverless function 226 corresponding to the resource 215 of the vehicle 204 from amongst a plurality of serverless functions 228 based on the safety level 224.

FIG. 2B is a block diagram 200B that illustrates an example of a system in accordance with some aspects of the present disclosure. The system includes a computing device 230 of the requesting entity 212. The computing device 230 includes a processing device 232 and memory 234. The computing device 230 transmits, to the vehicle 204, the message 214 including the resource indication 216 (i.e., the indication of the resource 215 of the vehicle 204) and the requesting entity indication 218 (i.e., the indication of the requesting entity 212). The computing device 230 obtains, from the vehicle 204 and based on the message 214, an indication of the (exposed) serverless function 226 corresponding to the resource 215, where the (exposed) serverless function 226 is based on a safety level 224 of the resource 215. The computing device 230 transmits, to the vehicle 204, a request 236 that indicates an action with respect to the resource 215 based on the (exposed) serverless function 226.

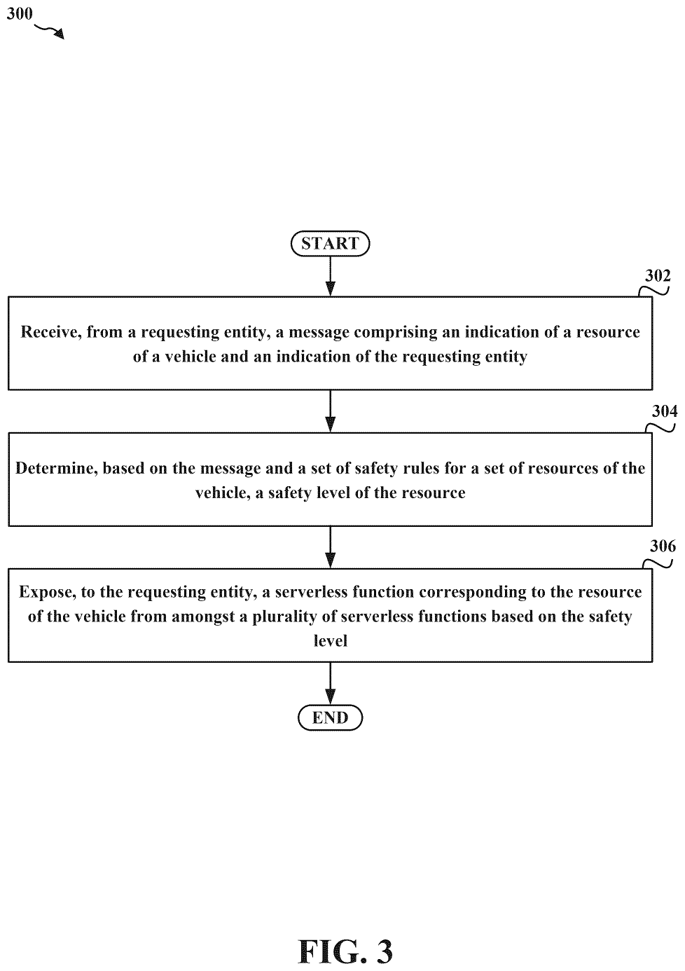

FIG. 3 is a flow diagram of a method 300 for fleetwide serverless functional safety protection for hybrid cloud interoperability in accordance with some aspects of the present disclosure. The method 300 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 300 may be performed by a computing device (e.g., the computing device 202 in FIG. 2A). In some aspects, the method 300 may be performed by a vehicle (e.g., the first vehicle 102 in FIG. 1A).

At block 302, a processing device receives, from a requesting entity, a message comprising an indication of a resource of a vehicle and an indication of the requesting entity. In an example, the requesting entity may be or include the cloud 108, the cloud service 106, the user computing device 112, the non-user computing device 114, the second vehicle 110, the trusted application 115, or the non-trusted application 117. In an example, the vehicle is the first vehicle 102 or the vehicle 204. In an example, the message may be or include the message 214, the indication of the resource of the vehicle may be or include the resource indication 216, and the indication of the requesting entity may be or include the requesting entity indication 218. In an example, the resource may be a resource included in the resources 120 (e.g., the vehicle control systems 122, the vehicle cabin control systems 124, etc.). In another example, the resource is the resource 215.

At block 304, the processing device determines, based on the message and a set of safety rules for a set of resources of the vehicle, a safety level of the resource. In an example, the set of safety rules include the safety rules 136 or the set of safety rules 220. In an example, the safety level is the safety level 224.

At block 306, the processing device exposes, to the requesting entity, a serverless function corresponding to the resource of the vehicle from amongst a plurality of serverless functions based on the safety level. In an example, the serverless function is the first serverless function 142 and the plurality of serverless functions includes the serverless functions 138. In another example, the serverless function is the serverless function 226. In one aspect, exposing the serverless function corresponding to the resource of the vehicle includes transmitting an indication of the serverless function to the requesting entity.

In one aspect, the serverless function abstracts a capability of the resource from an implementation of the resource. In a specific example, the serverless function indicates action(s) that a vehicle control system can perform without indicating how the vehicle control system performs the action. In one aspect, the serverless function defines a level of access to the resource.

In one aspect, the safety level may include an ASIL classification. For instance, the safety level may be ASIL A, ASIL B, ASIL C, or ASIL D. The ASIL classification may permit an interaction with the serverless function.

In one aspect, the processing device receives, from the requesting entity, a request that indicates an action with respect to the resource based on the serverless function. In an example, the request may be or include the request 236. In an example, the action may be or include receiving data from the requesting entity, transmitting data to the requesting entity, receiving data from another entity, transmitting data to another entity, controlling the vehicle, controlling a cabin system of the vehicle, or updating a vehicle system of the vehicle. In one aspect, the serverless defines allowed parameters within the request.

In one aspect, the processing device executes the action based on the request. For example, executing the action based on the request may include receiving the data from the requesting entity, transmitting the data to the requesting entity, receiving the data from another entity, transmitting the data to another entity, controlling the vehicle, controlling the cabin system of the vehicle, or updating the vehicle system of the vehicle. In one aspect, the serverless function defines allowed parameters in a response message that includes data transmitted to the requesting entity or data transmitted another entity. In one aspect, the serverless function defines allowed parameters in a received message that includes data received from the requesting entity or data received from another entity.

In one aspect, the processing device may activate, based on the request, the resource. For instance, if the resource is memory, the processing device may allocate a space within the memory for performance of the action.

In one aspect, the processing device may deactivate the resource subsequent to executing the action. For example, if the resource is memory, the processing device may deallocate a previously allocated space within the memory subsequent to performance of the action.

In one aspect, the processing device may obtain, prior to receiving the message and from a cloud service, the set of safety rules and the plurality of serverless functions. For example, the processing device may receive the set of safety rules and the plurality of serverless functions from the cloud service 106 (e.g., as part of a manufacturing process of the vehicle 204).

In one aspect, the serverless function may include a first serverless function when the safety level of the resource comprises a first safety level, where the serverless function may include a second serverless function when the safety level of the resource comprises a second safety level, and the first serverless function may be different from the second serverless function. For example, the first safety level may correspond to a relatively low importance of safety (e.g., ASIL A), and as such, the first serverless function may expose a relatively greater amount of capabilities of the resource, whereas the second safety level may correspond to a relatively high importance of safety (e.g., ASIL D), and as such, the second serverless function may expose a relatively fewer amount of capabilities of the resource.

In one aspect, the serverless function may include a first serverless function when the requesting entity comprises a first requesting entity, the serverless function may include a second serverless function when the requesting entity includes a second requesting entity, and the first serverless function may be different from the second serverless function. For example, the first requesting entity may be a trusted entity of the vehicle and as such, the first serverless function may expose a relatively greater amount of capabilities of the resource, whereas the second requesting entity may be a non-trusted entity of the vehicle and as such, the second serverless function may expose a relatively fewer amount of capabilities of the resource.

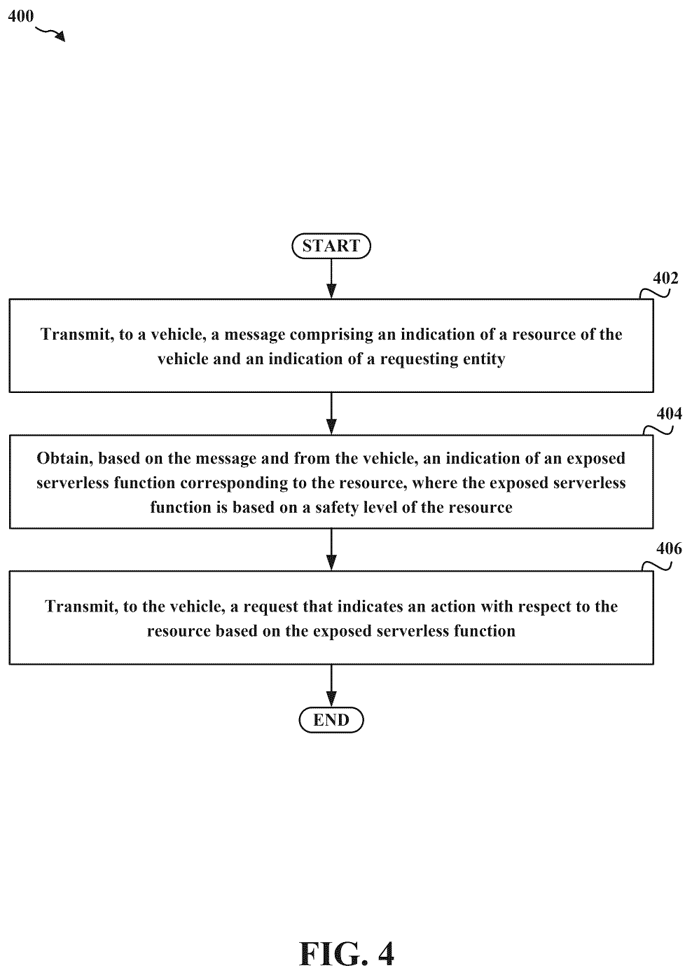

FIG. 4 is a flow diagram of a method 400 for fleetwide serverless functional safety protection for hybrid cloud interoperability in accordance with some aspects of the present disclosure. The method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 400 may be performed by a computing device (e.g., computing device 230 in FIG. 2B). In some aspects, the method 400 may be performed by the cloud 108, the cloud service 106, the user computing device 112, the non-user computing device 114, or the second vehicle 110.

At block 402, the processing device transmits, to a vehicle, a message comprising an indication of a resource of the vehicle and an indication of a requesting entity. In an example, the requesting entity may be or include the cloud 108, the cloud service 106, the user computing device 112, the non-user computing device 114, the second vehicle 110, the trusted application 115, or the non-trusted application 117. In an example, the vehicle is the first vehicle 102 or the vehicle 204. In an example, the message may be or include the message 214, the indication of the resource of the vehicle may be or include the resource indication 216, and the indication of the requesting entity may be or include the requesting entity indication 218. In an example, the resource may be a resource included in the resources 120 (e.g., the vehicle control systems 122, the vehicle cabin control systems 124, etc.). In another example, the resource is the resource 215.

At block 404, the processing device obtains, based on the message and from the vehicle, an indication of an exposed serverless function corresponding to the resource, where the exposed serverless function is based on a safety level of the resource. In an example, the exposed serverless function is the first serverless function 142 or the serverless function 226. In one aspect, obtaining the indication of the exposed serverless function includes receiving the indication of the exposed serverless function from the vehicle. In an example, the safety level is the safety level 224.

At block 406, the processing device transmits, to the vehicle, a request that indicates an action with respect to the resource based on the exposed serverless function. In an example, the request may be or include the request 236. The vehicle may perform the action based on the request. In an example, the action may be or include receiving data from the requesting entity, transmitting data to the requesting entity, receiving data from another entity, transmitting data to another entity, controlling the vehicle, controlling a cabin system of the vehicle, or updating a vehicle system of the vehicle. In one aspect, the serverless defines allowed parameters within the request.

In one aspect, the processing device may provision, to the vehicle, the set of safety rules and the plurality of serverless functions. For example, the processing device may provision the set of safety rules and the plurality of serverless functions to the first vehicle 102 (e.g., as part of a manufacturing process of the vehicle 204).

In one aspect, the serverless function abstracts a capability of the resource from an implementation of the resource. In a specific example, the serverless function indicates action(s) that a vehicle control system can perform without indicating how the vehicle control system performs the action. In one aspect, the serverless function defines a level of access to the resource.

In one aspect, the safety level may include an ASIL classification. For instance, the safety level may be ASIL A, ASIL B, ASIL C, or ASIL D. The ASIL classification may permit an interaction with the serverless function.

In one aspect, the serverless function may include a first serverless function when the safety level of the resource comprises a first safety level, where the serverless function may include a second serverless function when the safety level of the resource comprises a second safety level, and the first serverless function may be different from the second serverless function. For example, the first safety level may correspond to a relatively low importance of safety (e.g., ASIL A), and as such, the first serverless function may expose a relatively greater amount of capabilities of the resource, whereas the second safety level may correspond to a relatively high importance of safety (e.g., ASIL D), and as such, the second serverless function may expose a relatively fewer amount of capabilities of the resource.

In one aspect, the serverless function may include a first serverless function when the requesting entity comprises a first requesting entity, the serverless function may include a second serverless function when the requesting entity includes a second requesting entity, and the first serverless function may be different from the second serverless function. For example, the first requesting entity may be a trusted entity of the vehicle and as such, the first serverless function may expose a relatively greater amount of capabilities of the resource, whereas the second requesting entity may be a non-trusted entity of the vehicle and as such, the second serverless function may expose a relatively fewer amount of capabilities of the resource.

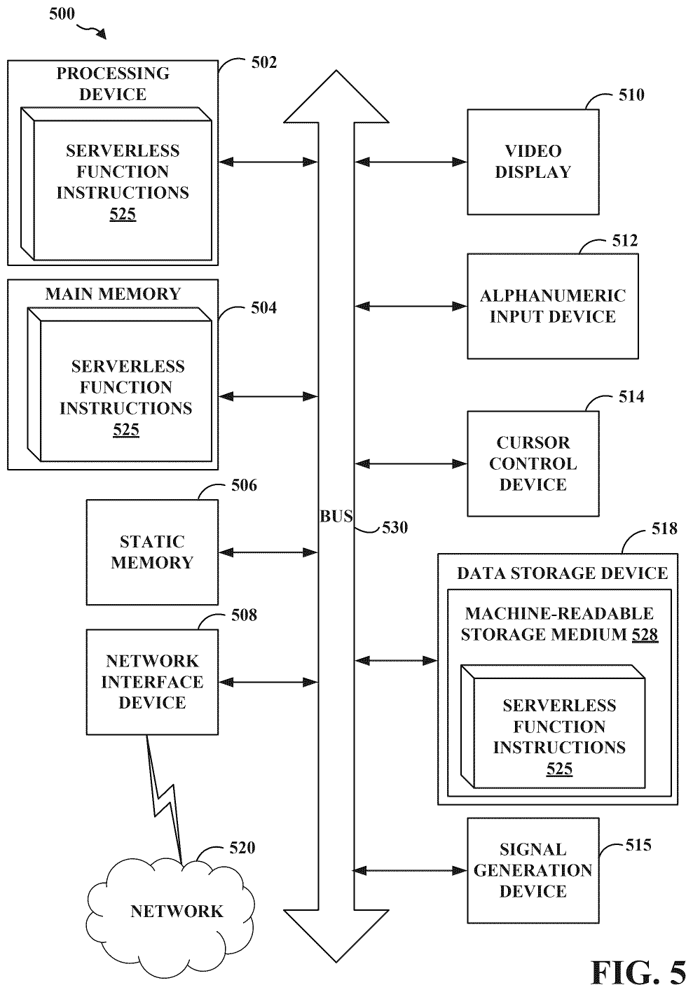

FIG. 5 illustrates a diagrammatic representation of a machine in the example form of a computer system 500 within which a set of instructions, for causing the machine to perform any one or more of the methodologies discussed herein for containerizing the packages of an operating system. More specifically, the machine may receive, from a requesting entity, a message comprising an indication of a resource of a vehicle and an indication of the requesting entity. The machine may determine, based on the message and a set of safety rules for a set of resources of the vehicle, a safety level of the resource. The machine may expose, to the requesting entity, a serverless function corresponding to the resource of the vehicle from amongst a plurality of serverless functions based on the safety level.

In alternative aspects, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or a bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one aspect, the computer system 500 may be representative of a server. In another aspect, the computer system 500 may be included in a vehicle (e.g., the first vehicle 102) and the computer system 500 may perform some or all of the functionality described herein as being performed by a vehicle. In a further aspect, the computer system 500 may be included in a requesting entity (e.g., another vehicle, a user computing device, a cloud service, a non-user computer device, a fleet management system, etc.) and the computer system 500 may perform some or all of the functionality described herein as being performed by a requesting entity.

The computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., a speaker). In one example, the video display unit 510, the alphanumeric input device 512, and the cursor control device 514 may be combined into a single component or device (e.g., an LCD touch screen).

The processing device 502 represents one or more general-purpose processing devices such as a microprocessor, a central processing unit, or the like. More particularly, the processing device 502 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), a network processor, or the like. The processing device 502 is configured with serverless function instructions 525, for performing the operations and steps discussed herein. For example, the serverless function instructions 525 may include instructions for receiving, from a requesting entity, a message comprising an indication of a resource of a vehicle and an indication of the requesting entity. The serverless function instructions 525 may include instructions for determining, based on the message and a set of safety rules for a set of resources of the vehicle, a safety level of the resource. The serverless function instructions 525 may include instructions for exposing, by a processing device and to the requesting entity, a serverless function corresponding to the resource of the vehicle from amongst a plurality of serverless functions based on the safety level.

The data storage device 518 may include a machine-readable storage medium 528 storing serverless function instructions 525 (e.g., software) embodying any one or more of the methodologies of functions described herein. The serverless function instructions 525 may also reside, completely or partially, within the main memory 504 or within the processing device 502 during execution thereof by the computer system 500; the main memory 504 and the processing device 502 also constituting machine-readable storage media. The serverless function instructions 525 may further be transmitted or received over the network 520 via the network interface device 508.

The machine-readable storage medium 528 may also be used to store the serverless function instructions 525 to perform a method for fleetwide serverless functional safety protection for hybrid cloud interoperability, as described herein. While the machine-readable storage medium 528 is shown in an exemplary aspect to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, a magnetic storage medium (e.g., floppy diskette), an optical storage medium (e.g., CD-ROM), a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular aspects may vary from these exemplary details and still be contemplated to be within the scope of the present disclosure.

Additionally, some aspects may be practiced in distributed computing environments where the machine-readable medium is stored on and or executed by more than one computer system. In addition, the information transferred between computer systems may either be pulled or pushed across the communication medium connecting the computer systems.

Aspects of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another aspect, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “receiving,” “determining,” “exposing,” “transmitting,” “executing,” “controlling,” “updating,” “activating,” “deactivating,” “obtaining” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass aspects in hardware, software, or a combination thereof.

What is claimed is:

1. A method, comprising:
receiving, from a requesting entity, a message comprising an indication of a resource of a vehicle and an indication of the requesting entity;
determining, based on the message and a set of safety rules for a set of resources of the vehicle, a safety level of the resource; and
exposing, by a processing device and to the requesting entity, a serverless function corresponding to the resource of the vehicle from amongst a plurality of serverless functions based on the safety level.

2. The method of claim 1, wherein the serverless function abstracts a capability of the resource from an implementation of the resource.

3. The method of claim 1, wherein the resource comprises at least one of:
a vehicle control system;
a vehicle cabin control system;
a computing resource of the vehicle;
an application executing on the vehicle;
an application programming interface (API) associated with the vehicle;
an electronic control unit (ECU) within the vehicle; or
firmware of the vehicle.

4. The method of claim 1, wherein the requesting entity comprises at least one of:
a second vehicle;
a user computing device;
a cloud service;
a non-user computing device;
a trusted application;
a non-trusted application; or
a fleet management system.

5. The method of claim 1, wherein the safety level comprises an automotive safety integrity level (ASIL) classification.

6. The method of claim 5, wherein the ASIL classification permits an interaction with the serverless function.

7. The method of claim 1, wherein exposing the serverless function corresponding to the resource of the vehicle comprises transmitting an indication of the serverless function to the requesting entity.

8. The method of claim 1, further comprising:
receiving, from the requesting entity, a request that indicates an action with respect to the resource based on the serverless function; and
executing the action based on the request.

9. The method of claim 8, wherein executing the action based on the request comprises at least one of:
receiving data from the requesting entity;
transmitting data to the requesting entity;
controlling the vehicle;
controlling a cabin system of the vehicle; or
updating a vehicle system of the vehicle.

10. The method of claim 8, wherein the serverless function defines allowed parameters within the request.

11. The method of claim 8, further comprising:
activating, based on the request, the resource; and
deactivating the resource subsequent to executing the action.

12. The method of claim 1, wherein the serverless function comprises a first serverless function when the safety level of the resource comprises a first safety level, wherein the serverless function comprises a second serverless function when the safety level of the resource comprises a second safety level, and wherein the first serverless function is different from the second serverless function.

13. The method of claim 1, wherein the serverless function comprises a first serverless function when the requesting entity comprises a first requesting entity, wherein the serverless function comprises a second serverless function when the requesting entity comprises a second requesting entity, and wherein the first serverless function is different from the second serverless function.

14. The method of claim 1, further comprising:
obtaining, prior to receiving the message and from a cloud service, the set of safety rules and the plurality of serverless functions.

15. The method of claim 1, wherein the serverless function defines a level of access to the resource.

16. A system, comprising:
a memory; and
a processing device, operatively coupled to the memory, to:
receive, from a requesting entity, a message comprising an indication of a resource of a vehicle and an indication of the requesting entity;
determine, based on the message and a set of safety rules for a set of resources of the vehicle, a safety level of the resource; and
expose, to the requesting entity, a serverless function corresponding to the resource of the vehicle from amongst a plurality of serverless functions based on the safety level.

17. The system of claim 16, wherein the serverless function abstracts a capability of the resource from an implementation of the resource.

18. The system of claim 16, wherein the processing device is further to:
receive, from the requesting entity, a request that indicates an action with respect to the resource based on the serverless function; and
execute the action based on the request.

19. A non-transitory computer-readable medium having instructions stored thereon which, when executed by a processing device, cause the processing device to:
receive, from a requesting entity, a message comprising an indication of a resource of a vehicle and an indication of the requesting entity;
determine, based on the message and a set of safety rules for a set of resources of the vehicle, a safety level of the resource; and
exposing, by the processing device and to the requesting entity, a serverless function corresponding to the resource of the vehicle from amongst a plurality of serverless functions based on the safety level.

20. The non-transitory computer-readable medium of claim 19, wherein the serverless function abstracts a capability of the resource from an implementation of the resource.
